(19) United States
(12) Patent Application Publication
(10) Pub. No.: US 2025/0271106 A1
(43) Pub. Date: Aug. 28, 2025

(54) INTERMEDIATE GAS STORE, ELECTROLYSIS SYSTEM, AND METHOD FOR PROTON EXCHANGE ELECTROLYSIS

(71) Applicant: Siemens Energy Global GmbH & Co. KG, München (DE)

(72) Inventors: Frank Hannemann, Röttenbach (DE); Andreas Volkmann, Erlangen (DE); Stefan Braun, Neukirchen-Vluyn (DE)

(21) Appl. No.: 18/846,708

(22) PCT Filed: Jan. 5, 2023
(86) PCT No.: PCT/EP2023/050142

§ 371 Date: Sep. 13, 2024

(30) Foreign Application Priority Data
Mar. 17, 2022 (DE) 10 2022 202 660.8

(51) Int. Cl. F17C 13/02; C25B 15/023; C25B 15/08

(52) U.S. Cl. CPC F17C 13/025; C25B 15/023; C25B 15/083; F17C 2205/0332; F17C 2221/012; F17C 2223/033; F17C 2225/0123; F17C 2227/0157; F17C 2250/0421; F17C 2250/0626

(57) ABSTRACT

The invention relates to an intermediate gas store for an electrolysis system, more particularly for low-pressure proton exchange electrolysis, including a storage vessel which has a storage space into which a channel of a gas removal unit leads, via which channel gas produced during the electrolysis can be introduced into the storage space. The storage vessel has a pressure control device, by means of which a pressure setpoint value can be applied to the gas introduced into the storage space. The pressure control device includes a diaphragm and an actuator, the actuator acting on the membrane in such a way that the pressure setpoint value can be established. The invention also relates to an electrolysis system having an intermediate gas store and to a method for operating an electrolysis system.

### BACKGROUND

The invention relates to an intermediate gas store for an electrolysis system for low-pressure proton exchange membrane electrolysis, and to an electrolysis system for low-pressure proton exchange membrane electrolysis and to a method for operating an electrolysis system for proton exchange membrane electrolysis.

Electrolysis involves using electric current to initiate a chemical reaction, in particular a redox reaction, with electrical energy being converted into chemical energy. The electrical energy required for this is provided by a DC voltage source having two electrical poles, an anode and a cathode. It is through two electrodes, the anode and the cathode, that a direct electric current is conducted into a conductive electrolyte, for example a conductive liquid. In the case of proton exchange membrane electrolysis (PEM electrolysis), conduction is achieved at least partly through a proton exchange membrane permeable to positively charged protons. At the electrodes, electrolysis, that is to say conduction of the direct current of the DC voltage source, for example by means of protons, from one electrode to the other, results in formation of reaction products of the electrochemical reaction from the substances or elements present in the electrolyte or liquid. Besides PEM electrolysis systems which operate in an acidic environment, alkaline electrolyzers are for example also known and commonly used.

The DC voltage source causes an electron deficiency in the electrode associated with the positive pole, the anode, and an excess of electrons in the electrode associated with the negative pole, the cathode. At the cathode, electroneutral or positively charged substances pick up electrons and are thereby reduced. At the anode, electrons are released into the electrode or anode, and the substance(s) there can be oxidized.

A common form of electrolysis is water electrolysis, by means of which water is decomposed into hydrogen and oxygen, where a simple reaction equation can read 2H₂O->2H₂+O₂. This can be achieved by means of proton exchange membrane electrolysis (PEM electrolysis), which involves cleavage of water in an electrolysis cell having a solid polymer electrolyte. The polymer electrolyte, more precisely a polymer electrolyte membrane or the proton exchange membrane, is responsible for the conduction of protons, the hydrogen ions, for the separation of product gases and for the electrical insulation of the electrodes. The product gases formed in low-pressure PEM electrolysis from water H₂O are molecular oxygen O₂ and molecular hydrogen H₂. Because of its solid structure, the polymer electrolyte membrane has a low gas transmission rate, which leads to product gas of very high purity. The maintenance of high gas purity is important for storage safety and for the direct use of the product in a fuel cell, for example.

Water electrolysis by means of PEM electrolysis is a promising technology for energy storage in conjunction with renewable energy sources because of, for example, dynamic reaction times and high efficiencies. For example, in the case of so-called power-to-gas concepts, it can store surplus power in the form of energy when there is temporary surplus power exceeding demand, for example when producing renewable energy.

Such a PEM electrolysis system is, for example, described in EP 3 489 388 A1, in which high gas purity of the product gases is achieved, particularly in the event of an ingress of extraneous gas due to a pressure loss and possible leaks, by provision of an intermediate gas store, the storage vessel of which is in the form of a membrane store. Said intermediate gas store is arranged downstream of the electrolyzer and fluidically connected thereto via pipelines, such that, for example, the product gas hydrogen can be accommodated by the storage vessel. As a result, a very simple measure is specified for absorbing pressure fluctuations, with the membrane store acting as a passive flow element and buffer vessel of suitable volume. The membrane mediates a certain pressure tolerance in relation to flow and, together with the sufficiently large vessel volume of the storage vessel, a certain inertia to the transmission of pressure fluctuations in the system, including for elements downstream in the direction of flow, such as a compressor. However, the measure described in EP 3 489 388 A1 is insufficient for industrial demands of water electrolysis and for stable operation in specific use cases. The passive absorption in relation to flow is found to be highly inflexible and disadvantageous for subsequence processes for hydrogen processing, particularly since pressure fluctuations within certain limits can be absorbed only to a very limited extent and operational flexibility is thus quite limited. This concerns particularly the use of atmospheric water electrolysis on a large industrial scale, where a particular need can be expected.

EP 3 489 388 A1 describes an intermediate gas store which is in the form of a simple membrane store and comprises a membrane. The storage vessel is lined with the membrane, which can expand in the direction of the vessel wall in the event of a slow rise in pressure. The membrane merely acts as a passive absorbing element and absorbs pressure fluctuations that occur, but does not keep the pressure constant at a target value or return it to a target value after absorption has occurred or after a change in pressure has occurred. Particularly for short-term pressure changes, this passive absorption concept is insufficient. Rapidly occurring pressure fluctuations of even relatively small amplitude in, for instance, the second range cannot be compensated for or absorbed. Moreover, the operating pressure is not adjustable to a desired value or reliably updatable, which is of increasing importance for particularly transient operation or partial-load operation and for safe supply of the generated hydrogen to the downstream compressor under a target pressure in the form of inlet pressure.

### SUMMARY

It is therefore an object of the present invention to specify an apparatus and a method, by means of which an electrolysis system can be configured for a particularly flexible mode of operation, such that load change together with simultaneously stable operation are possible.

The object directed to an apparatus is achieved according to the invention by an intermediate gas store for an electrolysis system, including a storage vessel having a storage space, opening into which is a channel of a gas removal unit, via which generated gas is introducible into the storage space during electrolysis, wherein the storage vessel includes a pressure control device by means of which a pressure target value is appliable to the gas introduced into the storage space, wherein the pressure control device includes a membrane and an actuator, wherein the actuator acts on the membrane (42) such that the pressure target value is settable.

The invention proceeds directly from the finding that conventional electrolysis systems are insufficiently configured for transient operation. In particular, there is a lack of dynamics in the mode of operation of an electrolysis system in the event of necessary operation-related load changes and a lack of connection flexibility in relation to subsequent processing processes, for instance for subsequent compression of the product gas hydrogen from the electrolysis process. A key finding is that the already known passive measures for absorption of pressure fluctuations in an electrolysis system are insufficient here. In the case of atmospheric water electrolysis, hydrogen and oxygen are generated at low positive pressures. Atmospheric water electrolyses are currently seen, from both economic and technological considerations, to be a particularly preferred solution for achieving high performance flexibility with simultaneous cost minimization. Use of these gases generated by electrolysis requires that pressure be elevated by means of a compressor in many downstream processes or for storage of the hydrogen. The low density of hydrogen means that piston or membrane compressors are mainly used for this purpose, since the conventional turbo compressors usually used for compression processes would be uneconomic to produce because of the high number of steps required. However, the design principle of piston compressors causes disadvantageous pressure fluctuations on both the suction side and the discharge side and these can lead to a reduction in the service life of the electrolysis or to operational outages. The compression downstream of electrolysis, but also other subsequent process steps, additionally have a dynamic behavior differing from the electrolysis in the case of transient processes and must be decoupled for stable operation. An interconnected store of fixed volume, the mode of action of which consists of pressure variation for injection and withdrawal processes, is not available for this purpose, since this pressure variation would be too low in the case of atmospheric applications and would lead to enormous storage volumes and thus enormous costs and space requirements.

Therefore, compared to the solutions in the prior art, the invention envisages pressure maintenance via a mode of operation with constant pressure. Here, the intermediate gas store can advantageously regulate very small and short-term pressure changes in the second range to the pressure target value in an effective manner. The downstream compression is no longer impacted by the pressure changes, owing to an isobaric operation of the intermediate gas store that is brought about by a change in volume of the storage volume via the combination of a membrane and an actuator as control element. The actuator acts here on the membrane such that the target pressure value is settable or is set instantaneously even in the case of small pressure fluctuations, for instance in the second range. Therefore, in the event of an instantaneous increase in pressure, a relatively large volume is released, and in the event of an instantaneous reduction in pressure, a relatively low volume. The intermediate gas store of the invention is flexibly usable in various electrolysis systems, preferably atmospheric electrolysis systems, meaning that use in alkaline electrolysis and in low-pressure proton exchange membrane electrolysis is advantageously possible.

The invention therefore proposes the use of an intermediate gas store under constant pressure for low-pressure gas storage of the generated hydrogen, the mode of action of which is change in volume and not change in pressure. For this purpose, the storage volume to be stored or to be buffered is changed at constant pressure and can thus bring about decoupling of the dynamic behavior of the processes and specifically the interactions of electrolysis and compression and avoid pressure fluctuations particularly efficiently. Buffering is advantageously achieved by a geometric change in volume of the storage space of the intermediate gas store, while the operating pressure in the system remains virtually constant. The design principle of the intermediate gas store allows the change in geometric volume of the vessel at virtually constant pressure by means of a membrane and the actuator, and so it can serve particularly advantageously as a compensation buffer between electrolysis and downstream compressor. Moreover, alignment of the mass flow rates of electrolysis and compressor is made possible by the respective control mechanisms of the two units, thus achieving stable operation.

In one embodiment, the actuator includes a control element which acts on the basis of its weight force on the membrane such that the pressure target value is set. This allows self-regulating adjustment and largely fluctuation-free pressure maintenance for the pressure control device, without complex actively controlled control elements and drives. The weight force of the control element on the membrane provides for a change in volume to allow an isobaric change in state of the gas. The pressure target value and hence the operating pressure can thus be kept largely constant.

In one embodiment, the storage vessel is, looking downstream in the flow direction of the generated gas, fluidically connectable to a gas remover device and/or a compressor device, wherein the pressure control device is arranged such that pressure maintenance of the pressure target value is achieved and transmission of pressure fluctuations through the storage vessel is avoided.

In one embodiment, the actuator includes a vertically guided piston rod which acts on the membrane, such that the pressure target value is brought about via the membrane position. In particular, the pressure target value is thus maintained and operation under constant pressure is made possible.

In one embodiment, there is provided a vertically arranged guide sleeve into which the piston rod movably engages. What is therefore achieved is a vertical guidance of the solid piston rod, and a precise vertical movement of the mass and action of force on the membrane for a required isobaric change in volume to counteract the pressure fluctuations of the gas that occur.

The atmospheric operation of the electrolyzer in an electrolysis system means that the change in volume by the membrane can advantageously be effected via mechanical devices, for example weights or spring hangers, and a relatively complex electrical control device can be avoided. Since the proposed intermediate gas store in low-pressure operation allows operation of the system between electrolysis and compressor in a particularly stable manner and at a virtually constant pressure, any damage to the electrolysis membrane by pressure fluctuations in the system is avoided.

A second aspect of the invention relates to an electrolysis system including an electrolyzer and including at least one intermediate gas store according to the invention that is connected to the electrolyzer. The use of the intermediate gas store in an electrolysis system is particularly advantageous because of the possibility of loading and operation of the intermediate gas store under constant pressure.

In one embodiment, there is provided in the electrolysis system a compressor device which is connected downstream in the flow direction of the generated gas to the intermediate gas store. What is therefore realized is a total system concept for an electrolysis system that integrates hydrogen generation in the electrolyzer, intermediate storage of the generated hydrogen product gas and subsequent compression.

In one embodiment, a pressure monitoring device is arranged between electrolyzer and intermediate gas store. More preferably, a pressure monitoring device is arranged between intermediate gas store and compressor. Monitoring of the inlet pressure on the inlet side of the intermediate gas store and of the outlet pressure on the outlet side on the intermediate gas store can therefore be carried out. Ideally, there is no difference or only a very slight difference between inlet pressure and outlet pressure and the two values are at the desired target pressure in regular operation. In the case of low-pressure protein exchange membrane electrolysis, this value is below 10 bar, preferably between 1.0 and 1.5 bar, and 1.1 bar are typically set. This is also the constant inlet pressure for the compressor device. The preferred pressure range between about 1.0 to 1.5 bar is advantageously usable for atmospheric electrolyses.

Besides operation and monitoring of the target pressure of the intermediate gas store, the pressure monitoring device additionally has safety advantages for operation of the electrolysis system, in particular the electrolyzer. For example, it is particularly advantageously possible by means of the pressure monitoring device to monitor the gas pressure in the connection lines and thus also at the site in the electrolysis cell or electrolysis module where the gas is formed, this making it possible, for example, to detect a drop in pressure, particularly in a range below the ambient pressure. In this connection, the pressure monitoring device may for example include a warning element which for example emits acoustic and/or optical warning signals, such that a drop in pressure can be responded to particularly rapidly, thereby making it possible for measures to be taken within a particularly short space of time in order to ensure, for example, particularly high gas purity of the production gas, particularly of the molecular hydrogen.

In one embodiment of the electrolysis system, a two-step control device includes a first control step configured as a leading power control and a second control step configured as a stabilizing pressure control, such that a controlled interaction of electrolysis and compression is achievable. The two-step control of constant pressure allows particularly stable operation.

In order to additionally improve operational stability in the case of transient load changes as well, a stepped control of electrolyzer and compressor device is proposed in a further advantageous embodiment of the electrolysis system. For this purpose, either the compressor or the electrolysis can be assigned the leading power control, which, in the case of a hydrogen electrolysis system, can be specified as hydrogen generation power or amount of generated hydrogen gas per unit of time, or current or current density of the electrolysis current. The downstream control function used is a pressure control which is assigned to the subordinate control device, either to the electrolysis or to the compressor as control variable. This pressure target value is simultaneously the desired pressure target value in the intermediate gas store. The pressure target value is to be chosen such that the membrane of the intermediate gas store can return to an intermediate position after completion of the transient process. The pressure target value can be adjusted by use of the membrane position. Owing to the described design principle of the intermediate gas store and owing to use of the stepped control, the operating pressure in the system between electrolysis and compressor is kept virtually constant and any damage to the electrolysis membrane by pressure fluctuations is prevented. Furthermore, a constant inlet pressure at the compressor or compressor device is provided for and a correspondingly stable compression process at the desired pressure target value, particularly without damaging feedback on the compressor, can be achieved.

A third aspect of the invention relates to a method for operating an electrolysis system. In order to operate an electrolysis system particularly advantageously for a particularly flexible mode of operation by means of the method, such that load change and transients with simultaneously stable operation are possible, the method according to the invention includes introducing generated gas into a storage vessel of an intermediate gas store during electrolysis via a channel of a gas removal unit opening into the storage vessel, and bringing the gas introduced into the storage vessel to a specified pressure target value by means of a pressure control device of the storage vessel, wherein the gas is supplied to a compressor device at the pressure target value, and wherein the gas is compressed in the compressor device.

In one embodiment, the electrolysis and the subsequent compression of gas generated in the electrolysis are conducted by way of a two-step control in a combined mode of operation, wherein, as first control step, the electrolysis is controlled via a leading power control with a power target value for the electrolysis power, and wherein, as second control step, control is carried out via a pressure control with a constant pressure target value for the compression.

Here, a pressure target value is set below 10 bar, in particular between 1.0 bar and 1.5 bar. In the case of low-pressure proton exchange membrane electrolysis, a pressure target value of about 1.1 bar is particularly advantageous. This achieves good adjustment and mode of operation for the operation of an atmospheric electrolysis system.

In the method, the power target value preferably used for the leading electrolysis power is the electrolysis current, the electrolysis current density or the product mass flow rate of generated hydrogen.

In one embodiment, in the event of a control intervention by the pressure control device, the pressure is regulated to the pressure target value by bringing about an isobaric change in volume of the gas. This configuration advantageously realizes maintenance of constant pressure.

Advantages and advantageous configurations of the first aspect of the invention are to be regarded as advantages and advantageous configurations of the second or third aspect of the invention, and vice versa.

Further advantages, features and details of the invention will become apparent from the following description of preferred exemplary embodiments and with reference to the drawing. The features and combinations of features mentioned above in the description and the features and combinations of features mentioned below in the figure description and/or shown solely in the individual figures are usable not only in the particular combination specified, but also in other combinations or alone, without departing from the scope of the invention.

### BRIEF DESCRIPTION OF THE DRAWINGS

Exemplary embodiments of the invention will be more particularly elucidated with reference to a drawing, where:

FIG. 1 shows an intermediate gas store for an electrolysis system for low-pressure proton exchange membrane electrolysis including a storage vessel according to the prior art;

FIG. 2 shows an intermediate gas store for an electrolysis system according to the invention; and

FIG. 3 shows an electrolysis system including an electrolyzer, an intermediate gas store and a compressor device according to the invention.

### DETAILED DESCRIPTION

In the figures, the same reference signs have the same meaning.

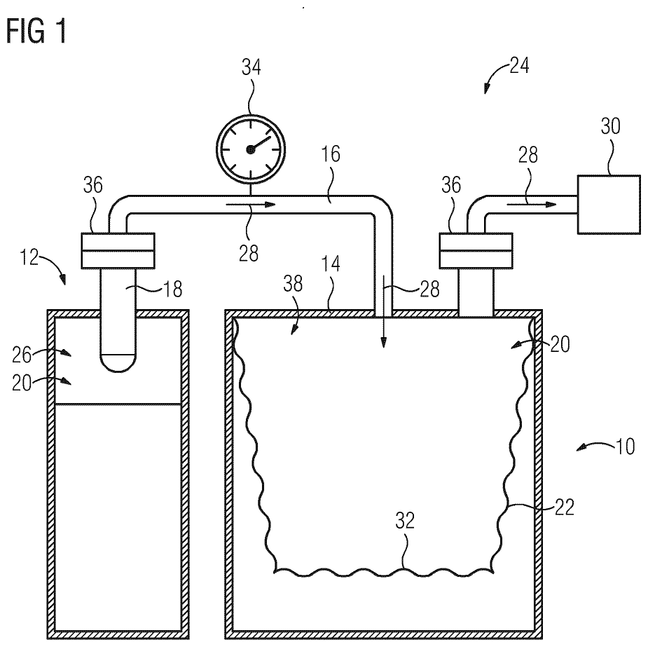

FIG. 1 shows an intermediate gas store 10 for an electrolysis system 12 for low-pressure proton exchange membrane electrolysis (low-pressure PEM electrolysis) including a storage vessel 14. The intermediate gas store 10 allows the PEM electrolysis system 12, which electrolyzes water H₂O into molecular oxygen O₂ and molecular hydrogen H₂ to obtain the respective product gas O₂ or H₂, to provide a respective product gas that is particularly pure. To this end, a channel 16 of a gas removal unit 18 opens into the storage vessel 14. Gas 20 which is generated during the electrolysis and known as product gas is introducible into the storage vessel 14 via the channel 16, said storage vessel 14 including at least one pressure element 22 by means of which a pressure is applied to the gas 20 introduced into the storage vessel. The intermediate gas store 10 primarily serves here to avoid an ingress of extraneous gas and to maintain a positive pressure with respect to a surrounding area 24 around the electrolysis system 12. Thus, in the case of a leak for example, i.e., a non-airtight site fluidically connected to the gas volume 26 occupiable by the generated gas 20 in the electrolysis system 12, the intermediate gas store 10 makes it possible to avoid the inflow of a process-extraneous gas by means of a positive pressure generated particularly by the pressure element 22.

In the exemplary embodiment shown, the storage vessel 14 is fluidically connected to a gas remover device 30 which lies downstream in the flow direction 28 of the generated gas 20, and any transmission of pressure fluctuations, which occur in the channel 16 and/or the gas remover device 30, through the storage vessel 14 is absorbable by means of the at least one pressure element 22. Alternatively, a compressor device 48, which is not shown in greater detail, may be fluidically connected to the storage vessel 14 instead of or in addition to the gas remover device 30.

In the embodiment according to the prior art shown, the storage vessel 14 is in the form of a membrane store comprising a membrane 32, at least part of the membrane 32 being in the form of the pressure element 22. Furthermore, the embodiment of the intermediate gas store 10 shown includes a pressure monitoring device 34 arranged in the channel 16 downstream of the gas removal unit 18 and additionally upstream of the storage vessel 14. The pressure monitoring device 34 makes it possible, for example, to monitor whether maintenance of a positive pressure with respect to the surrounding area 24 is being observed in the electrolysis system 12 and the gas store 10, so that an ingress of extraneous gas, for example from the surrounding area 24, can be avoided. This can be accomplished by the pressure monitoring device 34 causing, for example, movement of respective valves 36 from an open position, in which the gas 20 can flow through the respective valve 36, to a closed position, in which the flow of gas is stopped.

In the embodiment shown, a volume 38 of the storage vessel 14 for accommodation of the gas 20 generated by the electrolysis is greater than the volume, the so-called gas volume 26, of the electrolysis system 12, in particular an electrolysis cell or an electrolysis module of the electrolysis system 12. Therefore, the intermediate gas store 10 supplied by the gas 20 generated in the electrolysis can ensure over a very long period that it is possible to maintain a positive pressure in the regions of the electrolysis system 12, for example the gas volume 26, that are fluidically connected to the channel 16, a positive pressure, particularly as opposed to the surrounding area 24. The embodiment shown of the intermediate gas store 10 for low-pressure proton exchange membrane electrolysis with the electrolysis system 12 shown allows a method for operating the electrolysis system 12 to be carried out. During the electrolysis, generated gas 20 is introduced into the storage vessel 14 of the intermediate gas store 10 via the channel 16 of the gas removal unit 18 that opens into the storage vessel 14. The gas 20 introduced into the storage vessel 14 is subjected to application of a pressure by means of a pressure element 22, the membrane 32, of the storage vessel 14.

However, this passive absorption concept according to the prior art is insufficient, particularly for short-term pressure changes. It does not allow compensation for or absorption of particularly rapidly occurring pressure fluctuations, for instance within the second range. Moreover, the operating pressure is not adjustable to a desired value or updatable. The storage vessel 14 is lined with a membrane 32 which can expand in the event of a rise in pressure. However, this configuration is not suitable for keeping a pressure constant or for regulating to and keeping at a specified target value. Particularly in relation to how the membrane is to move back again on release of pressure. Therefore, what is achieved here is only absorption of pressure fluctuations on the generation side of the electrolyzer and thus a certain decoupling in relation to the subsequent processes—but not pressure control, as proposed according to the present invention for transients to be carried out stably.

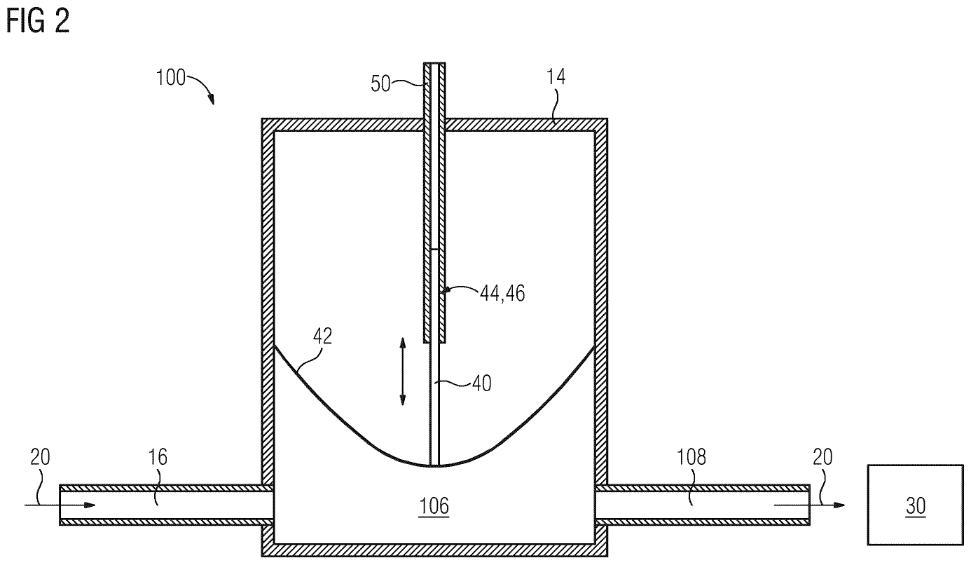

FIG. 2 shows an intermediate gas store 100 according to the invention. The intermediate gas store 100 includes a storage vessel 14 having a storage space 106 for a gas 20. The storage space 106 has a storage volume. A channel 16 for supply of gas 20 generated in the electrolysis opens into the storage space 106. This means that, for example, hydrogen as product gas is introducible to the storage space 106 from water electrolysis. The storage vessel 14 includes a pressure control device 40, such that the gas pressure of the gas 20 in the storage space 106 is settable or regulatable, particularly to a desired pressure target value that is as constant as possible. To this end, the pressure control device 40 includes a membrane 42 and an actuator 44. The actuator 44 acts on the membrane 42, such that the pressure target value is observed. The membrane 42 partitions off the storage space 106 having the storage volume gas tightly within the storage vessel 14, thus forming a subspace feedable with gas 20 from the electrolysis. The other subspace includes the actuator 44. The actuator 44 includes a control element 46 in the form of a vertically guided piston rod which is movably guided in a likewise vertically oriented guide sleeve 50. For removal of gas 20 from the storage space 106, there is provided a discharge channel 108 fluidically connected to the storage space 106. The discharge channel 108 can be realized by a discharge port or a pipeline, in particular in the form of a flange connection, and is downstream of the channel 16 for supply of gas 20. The discharge channel 108 serves for transfer of the gas 20 to provide it for further use. The further use and processing can, for instance, be effected in the gas remover device 30 which is not explained in greater detail and is connectable to the intermediate gas store 100.

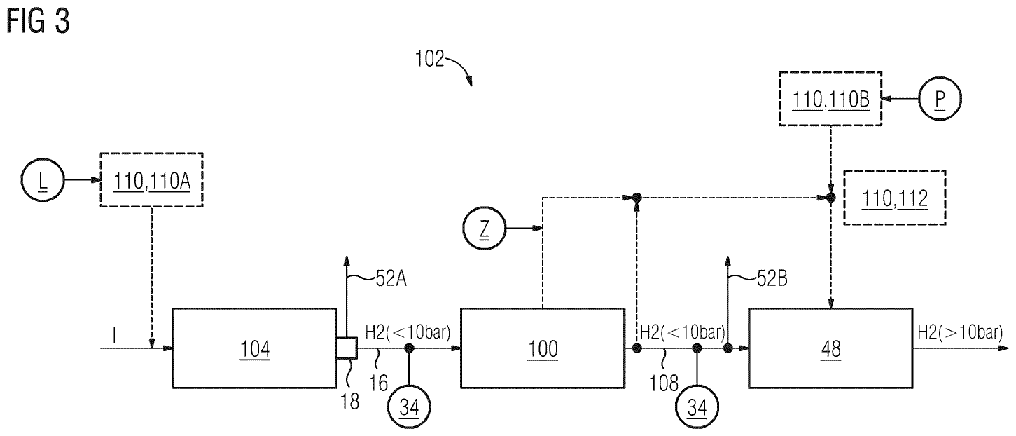

In the case of the intermediate gas store 100, the storage vessel is then, looking downstream in the flow direction of the generated gas 20, fluidically connected to a gas remover device 30. In a further and particularly advantageous application in electrolysis, the connection is made to a compressor device 48 not shown in greater detail in FIG. 1; this is explained in greater detail below using the example in FIG. 3 of an electrolysis system 102. The pressure control device 40 is arranged in the intermediate gas store 100 such that pressure maintenance of the pressure target value is achieved and transmission of pressure fluctuations through the storage vessel 14, or through the storage space 106, is avoided particularly effectively.

The actuator 44, which includes a piston rod guided vertically in a guide sleeve 50, acts on the membrane 42, such that the pressure target value is brought about via the membrane position. The pressure maintenance is thereby achieved in a largely self-regulating manner owing to the weight force of the piston rod which acts on the membrane 32 and which allows an isobaric change in volume of the storage space 106. As a result, relatively small pressure fluctuations in the second range can be easily compensated for in a self-regulating manner, with still sufficient control amplitude for use in electrolysis, particularly water electrolysis for generation of hydrogen as gas 20. This particularly interesting use of the intermediate gas store 100 is explained in greater detail below using the example.

FIG. 3 shows a schematic illustration of an electrolysis system 102 according to the invention. The electrolysis system 102 includes an electrolyzer 104, an intermediate gas store 100 and a compressor device 48. The intermediate gas store 100 is fluidically connected between the electrolyzer 104 and the compressor device 48 via the channel 16 and the discharge channel 108b, such that the product gas hydrogen H₂ is suppliable to the compressor device 48 from the electrolysis via the intermediate gas store 100. The compressor device 48 is connected downstream in the flow direction of the generated hydrogen H₂ to the intermediate gas store 100 via the discharge channel 108. For pressure monitoring, a pressure monitoring device 34 is connected into the gas-conducting line between electrolyzer 104 and intermediate gas store 100. Furthermore, a pressure monitoring device 34 is connected into the gas-conducting line between intermediate gas store 100 and compressor device 48. The electrolysis system 102 can be configured with an electrolyzer 104 for PEM electrolysis for low-pressure proton exchange membrane electrolysis, or be based on alkaline electrolysis.

The electrolysis system 102 is distinguished by a two-step control device including a first control step 110A and a second control step 110B. Here, the first control step 110A is formed by the leading power control with a power target value L. The power target value L characterizes the electrolysis power as leading variable for the operation of the electrolysis system 102 or the electrolysis power of the electrolyzer 104. Electrolysis current I is suitable as physical operating measurement variables and parameters for the first control step 110A. Alternative target values are, for example, given by the current density in the electrolyzer 104 or the hydrogen product mass flow rate in the electrolysis.

A pressure control which stabilizes electrolytic operation is provided as the second control step 110B, thus bringing about controlled interaction of electrolytic process and compression. In the second control step 110B, the operating pressure is specified as pressure target value P, as is to be set and observed in the intermediate gas store 100 or in the channel 16 and the discharge channel 108. Typically, in low-pressure proton exchange membrane electrolysis, pressure target values P of below 10 bar are desired and those of particularly between 1.0 and 1.5 bar are set. For low-pressure proton exchange membrane electrolysis, a pressure target value of about 1.1 bar is particularly advantageous. A specified inlet pressure at the compressor device 48 that is kept as constant as possible is settable by means of the pressure control of the second control step 110B. Reliable control of constant pressure is supported within certain limits in the control concept by the intermediate gas store 100 having the above-described advantages with respect to the compensation for small and very small pressure fluctuations in the second range in a fluctuation range of 10 mbar up to a few 100 mbar around the pressure target value of for example P=1.1 bar.

During operation of the electrolysis system 102, generated gas 20 is introduced into the storage vessel 14 of the intermediate gas store 100 having a storage space 106 during the electrolysis via the channel 16 of a gas removal unit 18 opening into the storage vessel 14, and the gas 20 introduced into the storage vessel 14 is brought to a specified pressure target value P by means of a pressure control device 40 of the storage vessel 14. The gas 20 having the pressure target value P is then supplied to a compressor device 48. The gas 20 is lastly further compressed in the compressor device 48 to a desired pressure for various applications or onward transfer. Concerning control, the electrolysis process and the subsequent compression of gas 20 generated in the electrolysis are conducted by way of a two-step control in a combined mode of operation. A first control step 110A for the electrolysis is formed by the leading power control with a power target value L for the electrolysis power, which is controlled accordingly. The second control step (110B) implemented is a pressure control with a constant pressure target value P, as possibly a freely specifiable inlet pressure for the subsequent compression of the gas 20 in the compressor device 48. In the case of the pressure control, in the event of a control intervention by the pressure control device 40, the pressure is regulated to the pressure target value P by bringing about an isobaric change in volume of the gas 20. A target/actual comparison 112 in relation to the specified pressure target value P can be additionally carried out via the positional state or the membrane position Z of the membrane 42 or of the control element 46 as measurement variable and the values reconciled, for a possibly necessary control intervention. If needed or else for safety-relevant switch-off operation, it is possible to safely release the gas 20, particularly hydrogen product gas, from the system via a release valve, for instance including for service purposes during downtime of the electrolysis system 102. It is found to be particularly advantageous here that, in the case of the intermediate gas store 100 of the invention during downtime of the electrolysis system 102, the membrane 42 travels completely downward into a resting position during downtime, solely because of the weight force of the membrane due to the vertically guided actuator 44, particularly in the form of a solid piston rod. This closes the storage space 106 for gas 20 or reduces the volume in the storage space—the gas 20 is pushed out. This means that hydrogen product gas is no longer in the storage space and the purge amount of required oxygen as purge gas for inertization is reduced accordingly for downtime management, for instance in the case of necessary service work. If necessary, gas 20 can be additionally released from the system via the release devices 52A, 52B.

1. An intermediate gas store for an electrolysis system, comprising a storage vessel having a storage space, opening into which is a channel of a gas removal unit, via which generated gas is introducible into the storage space during electrolysis, wherein the storage vessel comprises a pressure control device by means of which a pressure target value (P) is appliable to the gas introduced into the storage space, wherein the pressure control device comprises a membrane and an actuator, wherein the actuator acts on the membrane such that the pressure target value is settable.

2. The intermediate gas store as claimed in claim 1, characterized in that the actuator comprises a control element which acts on a basis of its weight force on the membrane such that the pressure target value is set.

3. The intermediate gas store as claimed in claim 1, characterized in that the storage vessel is, looking downstream in a flow direction of the generated gas, fluidically connectable to a gas remover device and/or a compressor device, wherein the pressure control device is arranged such that pressure maintenance of the pressure target value is achieved and transmission of pressure fluctuations through the storage vessel is avoided.

4. The intermediate gas store s claimed in claim 1, characterized in that the actuator comprises a vertically guided piston rod which acts on the membrane, such that the pressure target value is brought about via the membrane position.

5. The intermediate gas store as claimed in claim 4, characterized in that there is provided a vertically arranged guide sleeve into which the piston rod movably engages.

6. An electrolysis system for low-pressure proton exchange membrane electrolysis as claimed in claim 5, comprising an electrolyzer and comprising at least one intermediate gas store as claimed in any of the preceding claims that is connected to the electrolyzer.

7. The electrolysis system as claimed in claim 6, characterized in that there is provided a compressor device which is connected downstream in a flow direction of the generated gas to the intermediate gas store.

8. The electrolysis system as claimed in claim 6, characterized in that a pressure monitoring device is arranged between electrolyzer and intermediate gas store.

9. The electrolysis system as claimed in claim 7, characterized by a two-step control device which comprises a leading power control as first control step and a stabilizing pressure control as second control step, such that a controlled interaction of electrolysis and compression is brought about.

10. A method for operating an electrolysis system for low-pressure proton exchange membrane electrolysis, in which generated gas is introduced into a storage vessel of an intermediate gas store having a storage space during electrolysis via a channel of a gas removal unit opening into the storage vessel, and the gas introduced into the storage vessel is brought to a specified pressure target value (P) by means of a pressure control device of the storage vessel, wherein the gas is supplied to a compressor device at the specified pressure target value (P), and wherein the gas is compressed in the compressor device.

11. The method as claimed in claim 10, in which the electrolysis and the subsequent compression of gas generated in the electrolysis are conducted by way of a two-step control in a combined mode of operation, wherein, as first control step (110A), the electrolysis is controlled via a leading power control with a power target value (L) for an electrolysis power, and wherein, as second control step (110B), control is carried out via a pressure control at a constant pressure target value (P) for the compression.

12. The method as claimed in claim 10, in which the pressure target value is set below 10 bar, in particular between 1.0 bar and 1.5 bar.

13. The method as claimed in claim 11, in which the power target value (L) used for the electrolysis power is the electrolysis current (I), an electrolysis current density or a product mass flow rate of generated hydrogen.

14. The method as claimed in claim 10, in which, in an event of a control intervention by the pressure control device, the pressure is regulated to the pressure target value (P) by bringing about an isobaric change in volume of the gas.
